(19) United States
(12) Patent Application Publication
(10) Pub. No.: US 2014/0060471 A1
(43) Pub. Date: Mar. 6, 2014

(54) BIO-ADDITIVE FOR DIESEL FUEL JET FUEL, OTHER FUELS AND LUBRICANTS

(71) Applicant: Clyde Ritter, Post Falls, ID (US)

(72) Inventor: Clyde Ritter, Post Falls, ID (US)

(21) Appl. No.: 13/726,584

(22) Filed: Dec. 25, 2012

Related U.S. Application Data
(60) Provisional application No. 61/580,589, filed on Dec. 27, 2011.

(51) Int. Cl. F02B 43/02; C10L 1/18

(52) U.S. Cl. CPC F02B 43/02; C10L 1/1802
USPC 123/1 A; 44/308

(57) ABSTRACT

Methods of making fuel additives and fuel additive formulations are presented that include degummed lipid acid or lipid ester; a bean oil and/or seed oil; a pour point depressant; and glycerol monooleate or glycerol monostearate. The fuel additives can be added to any fuel and result in advantages such as an increased shelf life.

### CLAIM OF PRIORITY

This application claims the benefit of U.S. Provisional Patent Application 61/580,589 entitled “BIO-ADDITIVE FOR DIESEL FUEL JET FUEL, OTHER FUELS AND LUBRICANTS,” by Clyde Ritter, filed Dec. 27, 2011 (Attorney Docket Number 89-2), the entire contents of which are incorporated herein by reference.

### FIELD

This specification relates generally to biodiesel formulations and methods of use.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Bio-diesel is the name given to a variety of ester-based oxygenated fuels made from vegetable oils, fats, greases and other sources of triglycerides. Bio-diesel is a clean-burning diesel replacement fuel that can be used in compression ignition (CI) engines and is manufactured from renewable non-petroleum-based sources, including but not limited to, organic fats and oils (such as virgin vegetable oil), recycled oil (such as used fryer oil and grease trap materials), camelina sativa oil (false flax or wild flax oil), and animal fats (such as lard and beef tallow). Non-limiting examples of these feedstocks include soybean oil, peanut oil, coconut oil, palm oil, canola oil (which may also be referred to as rapeseed oil), algae oil, jatropha oil, animal fat tallow, waste vegetable grease, and other similar sources.

The basic biodiesel reaction involves a transesterification process to convert triglycerides in the feed stock to methyl esters. The transesterification process typically involves the reaction of a raw oil (source of triglycerides) with methanol or ethanol and an alkaline catalyst, such as sodium hydroxide or potassium hydroxide. Excess methanol is typically used to ensure that the process is driven to completion.

The alcohol and catalyst are mixed first and then the alcohol/catalyst mixture is mixed with the raw oil and allowed to react. Once the reactants are thoroughly mixed, the reaction begins and the raw oil begins to separate into methyl ester and glycerin (otherwise known as glycerol). Because the methyl ester is less dense than the glycerin, methyl ester floats to the top of the glycerin and may be separated from the glycerin by pumping the methyl ester off the top or by draining the glycerin off the bottom. A centrifuge or other separation means may also be used to separate the methyl ester from the glycerin by-product. Thereafter, the methyl ester is purified to produce the bio-diesel product.

Bio-diesel is produced in pure form (100% biodiesel or “B 100”), but is typically blended with conventional diesel at low levels between about 2% (B2) and about 20% (B20) in the U.S. and may be blended at higher levels in other parts of the world. While B2 biodiesels fuels may be used in conventional diesel engines without modification, higher level blends above approximately B5 (and up to B100) may require special handling and fuel management as well as vehicle modifications, such as the use of heaters (especially in colder climates) and different seals/gaskets that come into contact with the fuel. The level of care needed depends on a variety of factors, including, but not limited to the engine, manufacturer, and climate conditions, among others.

Bio-diesel has been designated an alternative fuel by the U.S. Department of Energy and the U.S. Department of Transportation, and is registered with the U.S. Environmental Protection Agency as a fuel and fuel additive. It can be used in any diesel engine (when blended with conventional diesel) and is compatible with existing petroleum distribution infrastructure.

Specifications for biodiesel have been implemented in various countries around the world. In the U.S., the specifications have been implemented through the American Society of Testing and Materials (ASTM). The ASTM specification for diesel is ASTM D975 and the ASTM standard for biodiesel is ASTM D6751. It is noted that the standard for biodiesel is as a blendstock for blending into conventional diesel and is not meant to be a specification for B100 alone. It is noted that both No. 1 and No. 2 petroleum diesel fuel (i.e., D1 and D2) may be blended with biodiesel for various reasons, including the need for lower temperature operation.

Previously produced biodiesel fuels have a number of problems that make them less desirable for use in fuels, including short shelf life, too much sulfur, the requirement for costly bonding agents, and a high cloud point.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Biodiesel is an alternative fuel formulated exclusively for diesel engines; biodiesel is made from vegetable oil or animal fats. Biodiesel can be mixed with petroleum diesel in any percentage, from 1 to 99, which is represented by a number following a B. For example, B5 is 5 percent biodiesel with 95 percent petroleum, B20 is 20 percent biodiesel with 80 percent petroleum, or B100 is 100 percent biodiesel, no petroleum.

Examples of formulations of a biodiesel fuel additive are provided that can be used blended with another fuel or oil. In some formulations it is blended with conventional biodiesel fuel (or oil) at concentrations of from about 1% to about 99% by volume (e.g., from 1% to 99%). Some formulations of the biodiesel fuel additive can be blended with conventional biodiesel fuel at 2% (B2) to 20% (B20) for use in conventional biodiesel engines throughout the world. Higher level blends (5%—B5 and higher) can be used in conventional diesel engines with some modifications, including but not limited to: adding a heater to keep the biofuel above a certain temperature, different seals/gaskets may be needed to prevent the blend with the biodiesel from leaking, separation from petroleum fuels at low temperatures, special handling, and fuel management.

While the biodiesel fuel additive has utility as a biodiesel fuel and/or additive, it can also be used as a fuel additive in other types of fuels or oils without limitation, including but not limited to: jet fuel, avgas, kerosene, lubrication oil, and fuel for any 2-stroke engine. In addition, the biodiesel fuel additive can also be used in engine oils without limitation. As such, as used herein the phrase biodiesel fuel additive and/or biodiesel fuel refers to any type of fuel and/or oil.

Formulations of a biodiesel fuel additives may include a first polyalpha olefin, a second polyalpha olefin, a polyolefinic ester, a calcium overbased sulfonate, and a bean or seed oil. In other formulations the biodiesel fuel additive does not have all of the elements or features listed and/or has other elements or features instead of or in addition to those listed.

Polyalpha olefins are polymers produced from a simple olefin (also called an alkene with the general formula CₙH₂ₙ. The polyalpha olefin can be any polyalpha olefin having a centistoke value of from about 2 to about 12. In some formulations, the first polyalpha olefin can be chosen from the group including: 2 centistoke, 3 centistoke, 4 centistoke, 5 centistoke, 6 centistoke, 7 centistoke, 8 centistoke, 9 centistoke, 10 centistoke, 11 centistoke, or 12 centistoke. In some formulations, the second polyalpha olefin can also be chosen from the group including 2 centistoke, 3 centistoke, 4 centistoke, 5 centistoke, 6 centistoke, 7 centistoke, 8 centistoke, 9 centistoke, 10 centistoke, 11 centistoke, or 12 centistoke. In some formulations, the first and second polyalpha olefin are chosen to have different centistoke values. In some formulations, the first polyalpha olefin has a 6 centistoke value and the second polyalpha olefin has a 2 centistoke value. The first polyalpha olefin can be included in the formulation for the biodiesel fuel additive at a percentage by volume of from about 4.5% to about 95.5%, including but not limited to: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 70, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 91.5, 92, 92.5, 93, 93.5, 94, 94.5, 95, 95.5, 96, 96.5, 97, 97.5, 98, 98.5, and 99%. In some formulations the first polyalpha olefin is included in the formulation for the biodiesel fuel additive at a percentage by volume of from about 20 to 80%. In some formulations the first polyalpha olefin is included at a percentage of from about 30 to 50%. In some formulations the first polyalpha olefin is included at a percentage of from about 40%. In some formulations the first polyalpha olefin is included at a percentage of from about 20% to about 80%. In some formulations the first polyalpha olefin is included at a percentage of from about 40% to about 60%. In some formulations, the amount of polyalpha olefin used depends on the desired outcome. For example, emission reduction versus improved fuel economy.

The second polyalpha olefin can be included in the formulation for the biodiesel fuel additive at a percentage by volume of from about 95.5 to about 4.5%, including, but not limited to: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 70, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 91.5, 92, 92.5, 93, 93.5, 94, 94.5, 95, 95.5, 96, 96.5, 97, 97.5, 98, 98.5, and 99. In some formulations the second polyalpha olefin is included in the formulation for the biodiesel fuel additive at a percentage by volume of from about 5 to 80%. In some formulations the second polyalpha olefin is included at a percentage of from about 5 to 30%. In some formulations the second polyalpha olefin is included at a percentage of from about 10%. In some formulations the second polyalpha olefin is included at a percentage of about 30%. In some formulations the second polyalpha olefin is included at a percentage of from about 20% to about 80%. In some formulations the second polyalpha olefin is included at a percentage of from about 40% to about 60%.

In some formulations the biodiesel fuel additive can also include poly olefinic ester. Poly olefinic esters are a type of jet engine lube oil (for example HATCO product #3212, 3214, 1625 and mil-PRF type C/I) The polyolefinic ester can be included at a percentage by volume of about 4.5 to about 5.5%, including 4.6, 4.7, 4.8, 4.9, 5, 5.1, 5.2, 5.3, 5.4, and 5.5%. In some formulations of the biodiesel fuel additive, the polyolefinic ester is included at 5%. In some formulations the biodiesel fuel additive can also include calcium overbased sulfonate. Calcium overbased sulfonates are detergents that can be diesel additives and are designed to clean metal surfaces within an engine and prevent the build-up of deposits. The C400-C™ Overbased Sulfonate is manufactured by Surpass Chemicals Limited, 10 Chemical court, West Hill, Ontario Canada, M1E3X7 and marketed by Witco Corporation, One American Lane, Greenwich Conn., USA 06831-2559. The calcium overbased sulfonate can be used at a particle size of from about 50 to about 100 angstroms, including 55, 60, 65, 70, 75, 80, 85, 90, and 95 angstroms or mixtures thereof. The calcium overbased sulfonate can be included in the formulation for the biodiesel fuel additive at a percentage by volume of about 4.5 to about 80.5%, including, but not limited to: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 70, 71.5, 72, 72.5, 73, 73.5, 74, 74.5, 75, 75.5, 76, 76.5, 77, 77.5, 78, 78.5, 79, 79.5, and 80%. In some formulations, the calcium overbased sulfonate is included at a volume of from about 5 to about 25%. In some formulations, the calcium overbased sulfonate is included at 5%. In some formulations, the calcium overbased sulfonate is included at 25%. In some formulations, the calcium overbased sulfonate is included at 40%. In some formulations, the calcium overbased sulfonate (C-400) is used at a percentage that reduces visible smoke from the diesel or other equipment.

The biodiesel fuel additive can also include any bean or seed oils such as castor oil, soybean oil, peanut oil, coconut oil, palm oil, canola oil, rapeseed oil, camelina sativa oil, jatropha oil, or combinations thereof. The bean or seed oil can be included at a percentage by volume of about 19.5% to about 20.5%, including 19.6, 19.7, 19.8, 19.9, 20%, 20.1, 20.2, 20.3, 20.4, and 20.5%. In some formulations, the bean or seed oil is included at 20%. In some formulations, the bean or seed oil is castor oil. In some formulations, the castor oil is used at a concentration that reduces measured emissions.

A method of preparing a biodiesel fuel additive, comprising admixing a first polyalpha olefin, a second polyalpha olefin, a polyolefinic ester, a calcium overbased sulfonate, and a bean or seed oil. In other formulations the biodiesel fuel additive does not have all of the elements or features listed and/or has other elements or features instead of or in addition to those listed. In some embodiments, the bean or seed oil is castor oil. In some embodiments, the first polyalpha olefin, a second polyalpha olefin, a polyolefinic ester, a calcium overbased sulfonate, and bean or seed oil are admixed at a temperature of from about 72 to 78° F., including 73, 74, 75, 76, and 77° F. In some embodiments the first polyalpha olefin, a second polyalpha olefin, a polyolefinic ester, a calcium overbased sulfonate, and bean or seed oil are admixed at about 76° F. In some embodiments, the biodiesel fuel additive is stored at a temperature of about 70-74° F., including 71, 72, and 73° F. In some embodiments, the biodiesel fuel additive is stored at a temperature of about 72° F. In some embodiments, the biodiesel fuel additive is stored at room temperature. In some embodiments, the method involves premixing the polyalpha olefins (PAO) and then adding the poly olefinic ester (POE) making a PAO/POE blend (PAO/POE), admixing 10% of the PAO/POE blend with the calcium overbased sulfonate, slowly adding the castor oil to the mix, mixing thoroughly, and adding the remaining PAO/POE blend. In some embodiments, adding the PAO/POE blend improves emissions, makes the biodiesel fuel additive impervious to temperature extremes, and lowers the cloud point character.

In some embodiments the biodiesel fuel additive is admixed with conventional diesel, avgas, automobile gas, jet fuel and/or engine oil at about 2 to about 99%, including 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99%. In some embodiments, the biodiesel fuel additive is admixed with conventional diesel at about 2 to about 20%. In some embodiments, the biodiesel fuel additive is admixed with avgas at 1 oz. per 10 gallons. In some embodiments, the biodiesel fuel additive is admixed with aircraft engine oil at 1 oz. per 2 quarts (qts). In some embodiments, the biodiesel fuel additive is admixed with automobile gas and/or jet fuel at 1 oz. per 15 gallons fuel.

In some embodiments, each of the steps of the method is a distinct step. In another embodiment, although depicted as distinct steps in the above description, may not be distinct steps. In other embodiments, the above method may not have all of the above steps and/or may have other steps in addition to or instead of those listed above. The steps of the above method may be performed in another order. Subsets of the steps listed above as part of method may be used to form their own method.

Synthetic biodiesel fuel additives are provided in Examples 1 and 2.

### EXAMPLE 1

Provided is a biodiesel fuel additive for emissions reduction and lowering the cloud point of diesel, bio diesel and jet fuel blended with bio fuels to include 100% bio diesel. (The % is percentage by volume). The biodiesel fuel additive is a synthetic product because it is chemically refined from components other than crude oil. The cloud point is significant in the U.S. because biodiesels produced from different feedstocks may perform differently in different geographic regions and climates. Cloud point test is performed as part of ASTM 6751 testing to characterize the low temperature operability of diesel fuel. It defines the temperature at which a cloud or haze appears in the fuel under prescribed test conditions. The cloud point for biodiesel blends is generally higher than it is for petroleum diesel fuel. The cloud point for the formula in example 1 was −33° F. The biodiesel fuel additive included:

| | |
|---|---|
| 40% | 6 centistoke polyalpha olefin |
| 30% | 2 centistoke polyalpha olefin |
| 5% | polyolefinic ester |
| 5% | calcium overbased sulfonate |
| 20% | castor oil |
| 100% | total composite mix. |

The mixture was mixed at 76° F. The mixture was stored at room temperature (72° F.). The blending procedure involved pre-mixing the 2 and 6 centistoke polyalpha olefin (PAO), then adding the 5% polyolefinic ester (POE). Then the calcium overbased sulfonate was mixed with 10% (by volume) of the PAO/POE blend using standard rotational mixing equipment (a paint mixer). The castor oil was added slowly to the mix and, after thoroughly blending (10 minutes), the remaining PAO/POE blend was added. Without being limited to the following analysis, the polyolefinic ester appears to be the catalyst. No purification was needed and there was no special storage requirement. The formulation involved a metered application of the components.

This formulation specifically lowered the cloud point and reduced the visible smoke from diesel, bio diesel and jet fuel combinations.

### EXAMPLE 2

Provided is a biodiesel fuel additive to lower emissions and improve fuel economy of diesel and jet engines using any applicable fuels, straight or bio blends. (The % is percentage by volume). The cloud point for the formula shown in Example 2 was −25° F. The biodiesel fuel additive included:

| | |
|---|---|
| 40% | 6 centistoke polyalpha olefin |
| 10% | 2 centistoke polyalpha olefin |
| 20% | castor oil |
| 5% | polyolefinic ester |
| 25% | calcium overbased sulfonate |
| 100% | total composite mix. |

The mixture was mixed at 76° F. The mixture was stored at room temperature (72° F.). The blending procedure involved pre-mixing the 2 and 6 centistoke polyalpha olefin (PAO), then adding the 5% polyolefinic ester (POE). Then the calcium overbased sulfonate is mixed with 10% (by volume) of the PAO/POE blend using standard rotational mixing equipment (a paint mixer). The castor oil was added slowly to the mix and after thoroughly blending (10 minutes), the remaining PAO/POE blend was added. Without being limited to the following analysis, the polyolefinic ester appears to be the catalyst. No purification was needed and there was no special storage requirement. The formulation involved a metered application of the components.

This formulation was thicker and more expensive than that shown in example 1, but it exhibited all of the benefits of the formulation in example 1 plus improved fuel economy.

Polyalpha olefins are available in several different viscosities stated in centistokes ie; (2 through 13 cts.) All can be used in the formulation to optimize formula for different applications. Calcium overbased sulfonates are also varied, though Chemtura product nomenclature C-400CR is preferred for the above purpose.

The formulas shown in Examples 1 and 2 were tested in certified labs and it was found that the formulations in examples 1 and 2 did not take any of the fuels tested out of spec, either ASTM, Mil spec. ASTM diesel fuels testing was performed under D-975 06-B, ASTM tests for gasoline were performed under D-4814, and jet fuels were tested under ASTM D-156, D-4176, D-86, D-1298, D-2386, D-130, D-381, D-1094, D-3948, D-93, D-3241, D-6304, and D-2276.

Both formulations in Examples 1 and 2 withstood storage for 6 months at −10° F. and +90° F., with no visible affects.

Example 3 provides a comparison of the properties of the biodiesel fuel additives as compared to a comparable fuel provided in U.S. Pat. No. 5,505,867.

### EXAMPLE 3

The biodiesel fuel additives shown in Examples 2 and 3 were compared to a comparable fuel additive provided in U.S. Pat. No. 5,505,867. The fuel in U.S. Pat. No. 5,505,867 consisted of 40% overbased sulfonate/10% jojoba oil/50% castor oil blended as taught therein. A variety of properties were tested including shelf life, freezing temperature, behavior at low temperatures, sulfur content, cloud point of fuels when mixed at a variety of concentrations, and lubrication ability. The tests were performed as follows:

Lubrication measures the anti-weld properties at point of contact. Lubrication was measured using the 4 ball test. In summary, 3 balls are put in a cylinder and the 4^{th} ball is put on top and is spring loaded (to apply pressure to the other 3). The oil is added, and the bottom of the cylinder is spun to make the balls wear. The number of millimeters of depth of the scar caused by the wearing is measured. Using the biodiesel fuel additives in examples 1 and 2, surprisingly the balls actually wore to a mirror finish, probably as a result of the calcium boding to the balls. Thus, the calcium prevents the parts in an engine from sticking.

The emissions test involved using a reference card. The reference card was a card with circles with balls inside. A wafer was placed in the tail pipe forcing the exhaust through the wafer, which had the appearance of the ball with the circle around it. On the reference card, the ball and circle #0 represented no engine running and the one with the highest number #9 was the engine running with nothing to filter the output. 2 measurements were taken 20 minutes apart. The first measurement immediately after adding the biodiesel additive was higher than #9. After 20 minutes running with the biodiesel additive, the measurement was reduced to between 2 and 3, showing a significant reduction in emissions. The specific emissions measurements are shown below.

Properties of Biofuel of U.S. Pat. No. 5,505,867

| Positive | Negative |
|---|---|
| Performs as advertised | Shelf life very short - separates in hours |
| Simple to formulate | Freezes solid at near 0° F. |
| Keeps bio-diesel in | Too much sulfur, cannot be sold in |
| suspension in diesel | regulated fuels |
| fuels at low temps. | |
| Reduces friction and | Cannot be used in jetfuels. (triglycerides) |
| wear on all interfacing | |
| parts of engine and | |
| fuel delivery systems. | |
| Reduces emissions. | Patent claims any calcium in suspension |
| | Requires costly bonding agent in formula. |
| | Does not lower cloud point of any fuels |

Properties of New Synthetic-based Product

| Positive | Negative |
|---|---|
| Indefinite shelf life | The formulation involves |
| | metered application |
| | of components |
| Will not freeze | |
| Lowers cloud point of diesel, biodiesel, jet | |
| fuels and bio jetfuels by 25° F. | |
| Keeps any biofuels added to diesel and | |
| jetfuels in suspension indefinitely in low | |
| temps. | |
| Preservative for rubber and elastomers in | |
| fuel systems. | |
| Provides superior lubrication for point of | |
| contact metals and all other components in | |
| fuel systems. | |
| Reduces measured emissions from diesel | |
| and jet engines. (measured 14% of carbon | |
| emissions.) | |
| Less costly to formulate than original | |
| product. | |
| Reduces triglycerides by 80% compared to | |
| original product. | |
| Does not take any fuels out of | |
| specifications (ASTM or Mil Spec) | |

The soot reduction test is a measurement of initial emissions reduction with the new synthetic product using the ECOM unit. The soot reduction test was performed on the biodiesel fuel additive from Examples 1 and 2 as follows: a Yanmar 20 hp (horsepower) 3 cylinder diesel with a 21.6 compression ratio was installed in a John Deere model 430 tractor™. The engine had never been exposed to Ca-40 g fuel additive and had 1900 hours total run time as a commercial operation equipment. The first smoke test was a test with no additive applied. The results were in the form of a wafer supplied with the ECOM portable testing unit. A copy of the soot comparison chart was included for graphic comparison. With the additive applied and run for 2 hours prior to testing, the following results were obtained for the emissions and soot tests: Measured toxic emissions recorded a slight reduction in CO₂ by 12%
reduction in NOX by 14%
increase in O₂ by 10%
reduction in measured soot by 80%

The reduction in measured soot was very significant. Engine noise was considerably reduced. Odor was reduced to almost imperceptible. After 3 hours run time with product, the engine picked up idle speed and had to be slowed back to 1200 rpm. Thus engines using the additive run significantly quieter and output about 10% more oxygen.

The freeze test was performed for 10 months at the temperatures discussed. The test at 90° F. was performed for 3 months. The freeze test can include the pour point and/or the cloud point. The pour point is the lowest temperature at which the fuel or fuel with the product applied is still liquid enough to allow paddle in a small container submersed in ice and methanol (called the Brookfield test).

The freeze test can also reference the cloud point which is the temperature at which wax crystals form, clump together and clogg fuel filters (which typically have a 5μ porosity). This is a better measure of freezing point. Untreated diesel/jet fuels will pour at −40° F., but will cloud up at minus 8° F. The low temperature degradation of the biodiesel fuel additives in examples 1 and 2 were tested for 10 months and no change was seen. It is likely that there would be no change for much longer, even 10 years.

The actual testing of jet fuel with the fuel additive of example 1 was at −33 F., but it is likely there will be no low temperature degradation up to −42° F. and even −47° F. Cloud point testing was done with diesel/jet fuels having the additive of example 1 applied at 1 oz per 10 gallons fuel.

The pour point of the concentrated product was tested at −30° F. by the Brookfield method. Once added to fuels the pour point is referencing fuel treated with the additive.

### EXAMPLE 6

2-stroke engines include small, portable, or specialized machine applications such as outboard motors, high-performance, small-capacity motorcycles, mopeds, underbones, scooters, tuk-tuks, snowmobiles, karts, ultralights, model airplanes (and other model vehicles) and lawnmowers. The two-stroke cycle is used in many diesel engines, most notably large industrial and marine engines, as well as some trucks and heavy machinery.

The biodiesel fuel additive taught in example 2 was used in a typical 2 stroke engine at ¼ oz per gal of gasoline in a leaf blower with very good results. As a two stroke replacement the biofuel additive increased the efficiency and/or decreased the fuel consumption by 20%. In addition, when the biodiesel fuel additive was used there was no smoke or odor from the exhaust of the engine. When jet skis were run with the example 2 fuel additive (¼ oz per gallon of gasoline), there was no oil slick on the water. Using the fuel additive from examples 2 (¼ oz per gallon of gasoline) did not build deposits in any of the engines tested.

### EXAMPLE 7

Aviation gasoline (Avgas) is a high-octane aviation fuel used to power many aircraft and racing cars. In Avgas the additive taught in examples 1 and 2 can replace the tetra ethyl lead because it performs the same function by controlling combustion as well as lubricity for the valve/seat operation.

The biodiesels taught in examples 1 and 2 were used in jet engines and/or in engine oil following ASTM D-1655-82 Mil spec 85470. The treat rate for avgas was 1 oz. per 10 gals. Avgas and 1 oz. per 2 quarts (qts) aircraft engine oil. (the treat rate for auto gas, diesel and jet fuel is 1 oz. per 15 gals. Fuel). There were many improvements, including 10% improvement in fuel economy. In use, it did not build deposits in the combustion chamber. Thus, the synthetic biodiesel of examples 1 and 2 can be used as a replacement for tetra ethyl lead in aviation gasoline and can be used to lower the Reid vapor pressure in avgas.

In a embodiment a biodiesel fuel additive composition may include: a combination of at least from about 4.5% to about 95.5% of a first 2-13 centistoke polyalpha olefin; with from about 95.5% to about 5.5% of a second 2-13 centistoke polyapha olefin; with from about 4.5% to about 5.5% polyolefinic ester with; from about 4.5% to about 80.5% calcium overbased sulfonate; and with from about 19.5% to about 20.5% bean or seed oil, wherein the first and second polyalpha olefins have different centistokes values and wherein the particle size of the calcium is between about 50 and 100 angstroms.

In a embodiment a biodiesel fuel additive composition may further include the premixing of the polyalpha olefins olefins (PAO) and then the adding of the poly olefinic ester (POE) making a PAO/POE blend (PAO/POE). In a embodiment a biodiesel fuel additive composition may further include the admixing 10% of the PAO/POE blend with the calcium overbased sulfonate. In a embodiment a biodiesel fuel additive composition may further include slowly adding the bean or seed oil to the mix. In a embodiment a biodiesel fuel additive composition may further include mixing thoroughly. In a embodiment a biodiesel fuel additive composition may further include adding the remaining PAO/POE blend.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A biodiesel composition comprising:
from about 4.5% to about 95.5.5% of a first 2-13 centistoke polyalpha olefin;
from about 95.5% to about 4.5% of a second 2-13 centistoke polyapha olefin;
from about 4.5% to about 5.5% polyolefinic ester;
from about 4.5% to about 80.5% calcium overbased sulfonate; and
from about 19.5% to about 20.5% bean or seed oil, wherein the first and second polyalpha olefins have different centistokes values and wherein the particle size of the calcium is between about 50 and 100 angstroms.

2. The biodiesel composition of claim 1, wherein the viscosity value of the first polyalpha olefin is 6 centistoke.

3. The biodiesel composition of claim 1, wherein the viscosity value of the second polyalpha olefin is 2 centistoke.

4. The biodiesel composition of claim 1, wherein the calcium overbased sulfonate is a C-400CR calcium overbased sulfonate.

5. The biodiesel composition of claim 1, wherein the bean or seed oil is castor oil.

6. The biodiesel composition of claim 1, wherein the composition has shelf life of at least 9 months.

7. The biodiesel composition of claim 1, wherein the composition will not freeze up to a temperature of −33° F.

8. The biodiesel composition of claim 1, wherein the addition to diesel, biodiesel, jet fuel, or bio jet fuels lowers the cloud point by at least 10° F.

9. The biodiesel composition of claim 7, wherein the cloud point is lowered by at least 25° F.

10. The biodiesel composition of claim 1, wherein the addition to diesel, biodiesel, jet fuel, or bio jet fuels reduces carbon emissions by at least 10%.

11. The biodiesel composition of claim 9, wherein the addition to diesel, biodiesel, jet fuel, or bio jet fuels reduces carbon emissions by at least 14%.

12. A method of making a biodiesel fuel additive composition comprising:
combining at least
from about 4.5% to about 95.5% of a first 2-13 centistoke polyalpha olefin; with
from about 95.5% to about 5.5% of a second 2-13 centistoke polyapha olefin; with
from about 4.5% to about 5.5% polyolefinic ester with;
from about 4.5% to about 80.5% calcium overbased sulfonate; and
with from about 19.5% to about 20.5% bean or seed oil, wherein the first and second polyalpha olefins have different centistokes values and wherein the particle size of the calcium is between about 50 and 100 angstroms.

13. A method of using a biodiesel fuel additive composition comprising:
adding into a fuel tank of an engine composition including at least
from about 4.5% to about 90.5% of a first 2-13 centistoke polyalpha olefin; with
from about 95.5% to about 4.5% of a second 2-13 centistoke polyapha olefin; with
from about 4.5% to about 5.5% polyolefinic ester with;
from about 4.5% to about 80.5% calcium overbased sulfonate; and
with from about 19.5% to about 20.5% bean or seed oil, wherein the first and second polyalpha olefins have different centistokes values and wherein the particle size of the calcium is between about 50 and 100 angstroms; and
running the engine on contents in the fuel tank.

14. The method of claim 12, wherein the bean/seed oil is castor oil.

15. The method of claim 12, wherein the composition is admixed at a temperature of about 76° F.

16. The method of claim 12, wherein the composition is stored at a temperature of about 72° F.

17. The method of claim 12, further comprising mixing the biodiesel fuel additive with conventional diesel at a concentration of about 2% to about 20%.

18. The method of claim 13, wherein the composition is admixed at a temperature of about 76° F.

19. The method of claim 13, wherein the composition is stored at a temperature of about 72° F.

20. The method of claim 13, further comprising mixing the biodiesel fuel additive with conventional diesel at a concentration of about 2% to about 20%.
